(19) United States
(12) Patent Application Publication
(10) Pub. No.: US 2026/0369570 A1
(43) Pub. Date: Nov. 19, 2026

(54) ELECTRODE MEMBER

(71) Applicant: TOYOTA JIDOSHA KABUSHIKI KAISHA, Toyota-shi (JP)

(72) Inventor: Junta TAKASU, Nagoya-shi (JP)

(73) Assignee: TOYOTA JIDOSHA KABUSHIKI KAISHA, Toyota-shi (JP)

(21) Appl. No.: 19/546,727

(22) Filed: Feb. 23, 2026

(30) Foreign Application Priority Data
May 14, 2025 (JP) 2025-081381

(51) Int. Cl. H01M 4/36; H01M 4/133; H01M 4/134; H01M 4/38; H01M 4/48; H01M 4/587; H01M 4/62

(52) U.S. Cl. CPC H01M 4/366; H01M 4/133; H01M 4/134; H01M 4/386; H01M 4/48; H01M 4/587; H01M 4/622

(57) ABSTRACT

The electrode member includes, in the following order, a current collector, a first negative electrode active material layer, a second negative electrode active material layer, and a separator. The second negative electrode active material layer includes a first Si-based active material, the separator includes a first surface facing the second negative electrode active material layer, and an adhesive layer is disposed on the first surface.

### CROSS-REFERENCE TO RELATED APPLICATION

This application claims priority to Japanese Patent Application No. 2025-081381 filed on May 14, 2025. The disclosure of the above-identified application, including the specification, drawings, and claims, is incorporated by reference herein in its entirety.

### BACKGROUND

### 1. Technical Field

The present disclosure relates to an electrode member.

### 2. Description of Related Art

Japanese Unexamined Patent Application Publication (Translation of PCT Application) No. 2020-509541 (JP 2020-509541 A) discloses a multi-layer electrode. In the multi-layer electrode, two or more electrode active material layers each include a carbon-based active material and a Si-based active material. A content of the Si-based active material in the electrode active material layer on a side farther from an electrode current collector is greater than a content of the Si-based active material in the electrode active material layer on a side closer to the electrode current collector.

### SUMMARY

The Si-based active material has a larger specific capacity than the carbon-based active material. On the other hand, the Si-based active material has a property of exhibiting significant swelling during charging. Due to swelling of the electrode active material layer caused by the Si-based active material, the electrode active material layer and a separator may become separated from each other. As a result, electrode durability may be deteriorated.

In JP 2020-509541 A, improvements in electrode durability and battery performance have been confirmed by providing two or more electrode active material layers and varying the contents of the carbon-based active material and the Si-based active material in each layer. However, there remains room for improvement in durability.

An object of the present disclosure is to improve durability.

Hereinafter, technical configurations and effects of the present disclosure will be described. However, the mechanism of action includes estimation. The mechanism of action does not limit the technical scope of the present disclosure.

[1] An electrode member includes:
a current collector;
a first negative electrode active material layer;
a second negative electrode active material layer; and
a separator, in order of the current collector, the first negative electrode active material layer,
the second negative electrode active material layer, and the separator.
The second negative electrode active material layer includes a first Si-based active material.
The separator includes a first surface facing the second negative electrode active material layer.
An adhesive layer is disposed on the first surface.

FIG. 1 is a conceptual cross-sectional view for describing an example of a change in an electrode member during charging and discharging in the related art. Since a second negative electrode active material layer 22b includes a first Si-based active material, when a battery including an electrode member 40 is charged, the second negative electrode active material layer 22b may swell, and a separator 30 may deform following the expansion. In addition, even when the second negative electrode active material layer 22b contracts due to discharging, the separator 30 may not return to the original shape, and there is a possibility that the separator 30 and the second negative electrode active material layer 22b may become separated from each other.

FIG. 2 is a conceptual cross-sectional view for describing an example of a change in an electrode member during charging and discharging in the present embodiment. As in FIG. 1, when the battery including the electrode member 40 is charged, the second negative electrode active material layer 22b may swell, and the separator 30 may deform following the expansion. On the other hand, in the present embodiment, an adhesive layer 31 is disposed between the separator 30 and the second negative electrode active material layer 22b. Therefore, even when the second negative electrode active material layer 22b contracts due to discharging, the separation between the separator 30 and the second negative electrode active material layer 22b can be suppressed. As a result, an improvement in durability is expected.

[2] In the electrode member according to [1],
the first negative electrode active material layer may include a second Si-based active material, and
a mass fraction of the second Si-based active material in the first negative electrode active material layer may be lower than a mass fraction of the first Si-based active material in the second negative electrode active material layer.

The Si-based active material can contribute to improving energy density and reducing resistance. A first negative electrode active material layer 22a that is not in contact with the adhesive layer 31 includes a second Si-based active material. Even in this case, the mass fraction of the second Si-based active material in the first negative electrode active material layer 22a is lower than the mass fraction of the first Si-based active material in the second negative electrode active material layer 22b. Accordingly, while suppressing the separation between a current collector 21 and the first negative electrode active material layer 22a, an improvement in battery performance is expected.

[3] In the electrode member according to [1] or [2],
the second negative electrode active material layer and the adhesive layer may include a binder, and
the binder may include an acrylic polymer.

When an acrylic polymer is included as a binder in the second negative electrode active material layer 22b and the adhesive layer 31, an improvement in adhesion strength between the second negative electrode active material layer 22b and the adhesive layer 31 is expected.

In the electrode member according to [2] or [3], the first Si-based active material and the second Si-based active material may include at least one selected from the group consisting of Si, a Si-based alloy, SiO, and a Si—C composite material.

Hereinafter, an embodiment of the present disclosure (hereinbelow, can also be simply described as “the present embodiment”) will be described. However, the present embodiment does not limit the technical scope of the present disclosure. The present embodiment is an example in all respects. The present embodiment is not restrictive. The technical scope of the present disclosure includes all changes within the meaning and the scope that are equivalent to the description of the claims. For example, extracting arbitrary configurations from the present embodiment and arbitrarily combining the configurations are contemplated from the beginning.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual cross-sectional view for describing an example of a change in an electrode member during charging and discharging in the related art;

FIG. 2 is a conceptual cross-sectional view for describing an example of a change in an electrode member during charging and discharging in the present embodiment;

FIG. 3 is a conceptual diagram showing an example of a non-aqueous electrolyte secondary battery in the present embodiment;

FIG. 4 is a graph showing a capacity retention rate of each evaluation cell with respect to the number of cycles in Reference Test 1; and

FIG. 5 is a graph showing the swelling amount of each evaluation cell with respect to the charging and discharging time in Reference Test 2.

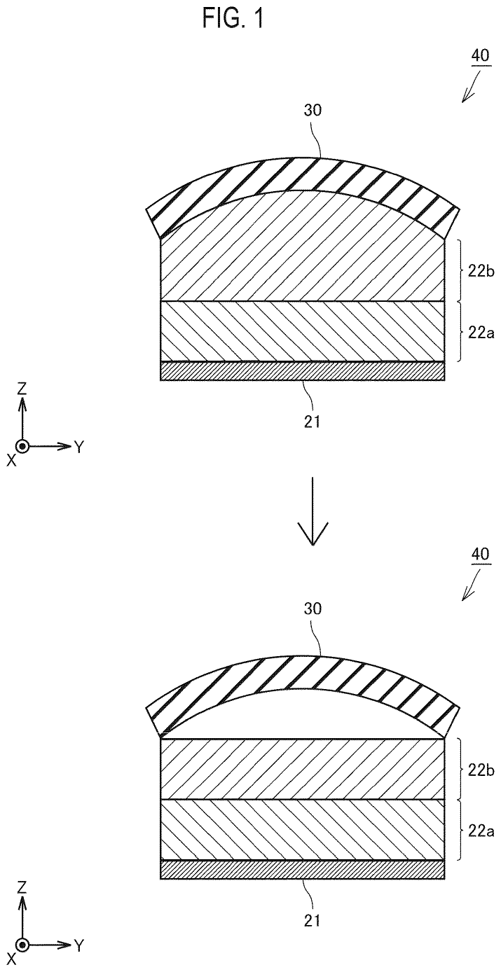

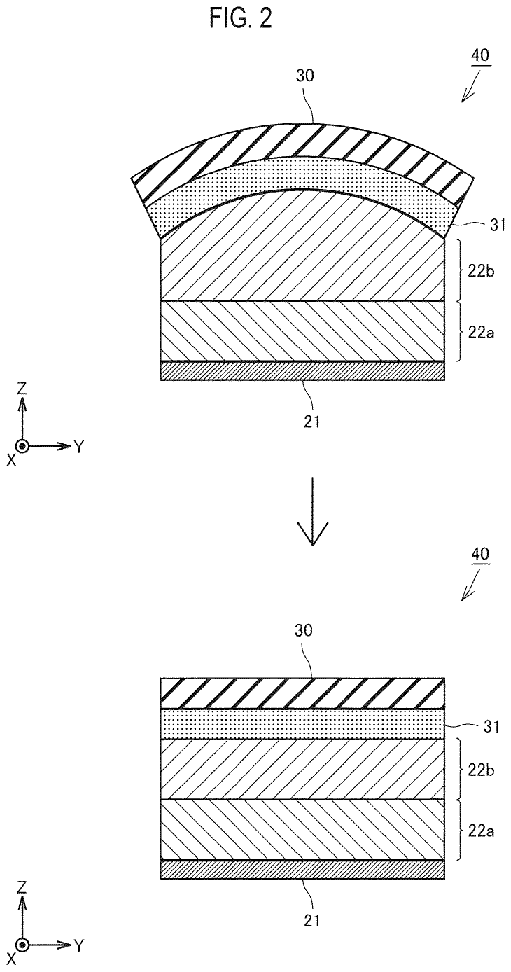

### DETAILED DESCRIPTION OF EMBODIMENTS

### Terms and Phrases

The terms “comprise”, “include”, “have”, and variations thereof are open-ended expressions. A structure expressed in an open-ended manner may further include or may not include additional elements in addition to essential elements. The description of “consisting of” is a closed expression. However, even in the structure expressed in a closed manner, additional elements that are usually accompanying impurities or irrelevant to the target technique may be included. The description of “substantially consisting of” is a semi-closed expression. In the structure expressed in a semi-closed manner, the addition of elements that substantially do not affect the basic and novel characteristics of the target technique is acceptable.

Geometric terms should not be interpreted in a strict sense. Examples of the geometric terms include “parallel”, “perpendicular”, and “orthogonal”. For example, a direction, an angle, a distance, and the like may be relatively displaced within a range in which substantially the same or similar functions are obtained. The geometric terms can include, for example, a design, work, or manufacturing tolerance or error. The dimensional relationships in each drawing sometimes do not agree with the actual dimensional relationships. In order to help the understanding of the reader, sometimes the dimensional relationships in each drawing are changed. For example, a length, a width, a thickness, and the like may be changed. Some configurations may be omitted.

Unless otherwise specified, the singular form is not limited to one element. The singular form also includes a plurality of elements.

The “particle diameter” is specified by microscopy. The particle diameter indicates an arithmetic average of a long side and a short side in a minimum bounding rectangle (MBR) of a two-dimensional image of the particle. The “average particle diameter” indicates an arithmetic average of particle diameters of 100 particles randomly extracted. It should be noted that various image analyses in the present embodiment may be performed by software. For example, “ImageJ” or the like may be used.

The “Si-based active material” is a general term for the first Si-based active material and the second Si-based active material. The Si-based active material includes Si (or a Si compound, a Si alloy, or the like) that can be alloyed with Li. The Si-based active material may include, for example, at least one selected from the group consisting of Si (pure Si), a Si-based alloy, SiO, and a Si—C composite material. SiO indicates composite particles represented by a general formula “SiOₓ (0<x<2)”. The Si—C composite material indicates composite particles including at least one of Si and SiO, and carbon. For example, Si may be supported on a carbon material. The first Si-based active material and the second Si-based active material may be the same or different from each other.

The “negative electrode active material layer” is a general term for the first negative electrode active material layer and the second negative electrode active material layer.

The electrode member in the present embodiment can be suitably used in a non-aqueous electrolyte secondary battery such as a lithium ion secondary battery. Hereinafter, the electrode member in the present embodiment will be described as being used in a non-aqueous electrolyte secondary battery.

### Non-Aqueous Electrolyte Secondary Battery

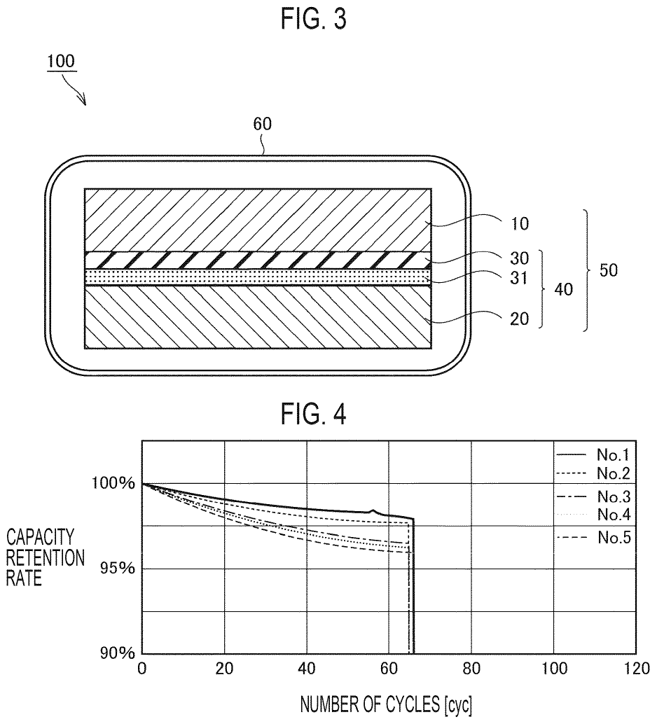

FIG. 3 is a conceptual diagram showing an example of a non-aqueous electrolyte secondary battery in the present embodiment. The non-aqueous electrolyte secondary battery 100 may include, for example, a power generation element 50 and a case 60. The case 60 accommodates the power generation element 50. The case 60 may be, for example, a metal container, an aluminum laminated film pouch, or the like. The power generation element 50 may include, for example, a positive electrode 10, a negative electrode 20, a separator 30, an adhesive layer 31, a non-aqueous electrolyte (not shown), and the like. The power generation element 50 may be, for example, a wound type or a laminated type. The power generation element 50 may have a monopolar structure or a bipolar structure. The non-aqueous electrolyte is a Li ion conductor. The non-aqueous electrolyte may include, for example, a Li salt and an organic solvent. The non-aqueous electrolyte may be, for example, impregnated into the separator 30. The non-aqueous electrolyte may include, for example, a polymer electrolyte, a gel electrolyte, or a solid electrolyte. The solid electrolyte may include, for example, a sulfide solid electrolyte, an oxide solid electrolyte, a halide solid electrolyte, or the like. The positive electrode 10 includes a positive electrode active material. The positive electrode active material may include, for example, a lithium transition metal composite oxide (Li[NiCoMn]O₂), a lithium phosphate compound (Li[FeMn]PO₄), or the like. It should be noted that the description of [NiCoMn], [FeMn], and the like indicates that the total composition ratio of the components within the brackets [] is “1”. The composition ratio of each component is optional as long as the total is 1. For example, the composition ratio of some components may be zero.

### Electrode Member

The electrode member 40 includes the negative electrode 20 and the separator 30.

The negative electrode 20 may be, for example, in the form of a sheet. The negative electrode 20 has a multi-layer structure. The negative electrode 20 includes a current collector 21, a first negative electrode active material layer 22a, and a second negative electrode active material layer 22b in this order in a thickness direction. The negative electrode active material layer may be disposed on a part of a surface of the current collector 21 or may be disposed on the entire surface. The negative electrode active material layer may be disposed on only one surface of the current collector 21 or may be disposed on both surfaces of the current collector 21. The current collector 21 may include, for example, a metal foil (a Cu foil, a Ni foil, or the like), a conductive resin layer, or the like. The current collector 21 may have a thickness of, for example, 1 μm to 100 μm.

The negative electrode 20 may further include any element as long as the current collector 21, the first negative electrode active material layer 22a, and the second negative electrode active material layer 22b are included in this order. For example, the negative electrode 20 may include the current collector 21, the first negative electrode active material layer 22a, a binder layer (not shown), and the second negative electrode active material layer 22b in this order. For example, a conductive layer, an adhesion layer (both not shown), or the like may be disposed between the first negative electrode active material layer 22a and the current collector 21. For example, the negative electrode 20 may include a third negative electrode active material layer (not shown) between the first negative electrode active material layer 22a and the second negative electrode active material layer 22b.

Each layer included in the negative electrode 20 may be, for example, a coating layer. The coating layer indicates a layer produced by applying a coating material. Each coating material may be applied at substantially the same time or may be applied sequentially.

Each layer may independently have any thickness. The thicknesses of the layers may be substantially the same or different from each other.

Each layer may independently have any basis weight. The basis weights of the layers may be substantially the same or different from each other. It should be noted that the “basis weight” indicates a mass per unit area.

Each layer may independently have any porosity. The porosities of the layers may be substantially the same or different from each other. It should be noted that the “porosity” is specified by an image analysis method. The pores and the solids are distinguished by binarizing the cross-sectional SEM images of each layer. The porosity is obtained by dividing the total area of pores (total number of pixels) by the area of the entire layer.

The second negative electrode active material layer 22b is an upper layer. The second negative electrode active material layer 22b may be directly provided on a surface of the first negative electrode active material layer 22a. The second negative electrode active material layer 22b directly contacts the adhesive layer 31 disposed on the first surface of the separator 30 in the non-aqueous electrolyte secondary battery 100. The second negative electrode active material layer 22b constitutes the outermost surface of the negative electrode 20. The second negative electrode active material layer 22b includes a negative electrode active material and a binder. The second negative electrode active material layer 22b may further include a conductive material or the like. The second negative electrode active material layer 22 b may include, for example, by mass fraction, 0% to 10% of a conductive material, more than 0% to 10% of a binder, with the remainder being a negative electrode active material. The second negative electrode active material layer 22b may include, for example, by mass fraction, 0.5% to 1.5% of a conductive material, 0.5% to 3% of a binder, with the remainder being a negative electrode active material.

The negative electrode active material in the second negative electrode active material layer 22b includes the first Si-based active material. For example, the negative electrode active material in the second negative electrode active material layer 22b may consist of the first Si-based active material.

For example, the negative electrode active material in the second negative electrode active material layer 22b may further include another negative electrode active material. The other negative electrode active material may include, for example, natural graphite, artificial graphite, lithium titanate, a Sn-based alloy, SnO, pure Li, a Li-based alloy, or the like.

A mass fraction “M_{1S}” of the first Si-based active material in the second negative electrode active material layer 22 b may be, for example, 1% or more, 3% or more, 5% or more, 10% or more, 15% or more, 20% or more, or 25% or more. The mass fraction “M_{1S}” of the first Si-based active material in the second negative electrode active material layer 22b may be, for example, 30% or more, 40% or more, 50% or more, 60% or more, 70% or more, 80% or more, 90% or more, 95% or more, or 100%. The mass fraction “M_{1S}” may be, for example, 95% or less, 90% or less, 80% or less, 70% or less, 60% or less, 50% or less, 40% or less, 30% or less, 25% or less, 20% or less, 15% or less, 10% or less, 5% or less, or 3% or less.

The first Si-based active material may have any average particle diameter. The average particle diameter may be, for example, 0.1 μm or more, 1 μm or more, 5 μm or more, 10 μm or more, or 15 μm or more. The average particle diameter may be, for example, 30 μm or less, 20 μm or less, 15 μm or less, or 10 μm or less. It should be noted that the same range applies to the second Si-based active material described later.

The binder may include, for example, at least one selected from the group consisting of styrene butadiene rubber (SBR), carboxymethyl cellulose (CMC), polyvinylidene fluoride (PVdF), polytetrafluoroethylene (PTFE), and an acrylic polymer. The mass fraction of the binder may be substantially constant throughout the entire region of the negative electrode active material layer. The mass fraction of the binder may be locally different. For example, the mass fraction of the binder may be different between the layers.

The acrylic polymer may be a homopolymer or a copolymer. At least a part of the constituent units of the acrylic polymer is derived from an acrylic monomer. The acrylic monomer may have, for example, at least one of an acrylic group or a methacrylic group. The acrylic monomer may include, for example, at least one selected from the group consisting of acrylic acid, acrylic acid ester, methacrylic acid, and methacrylic acid ester. The acrylic monomer may include, for example, at least one selected from the group consisting of ethyl acrylate, methyl acrylate, butyl acrylate, 2-ethylhexyl acrylate, isononyl acrylate, hydroxyethyl acrylate, methyl methacrylate, glycidyl methacrylate, acrylonitrile, acrylamide, and acrylamide. A part of the constituent units of the acrylic polymer may be derived from a monomer other than the acrylic monomer. For example, a part of the constituent units may be derived from styrene.

The first negative electrode active material layer 22a is a lower layer. The first negative electrode active material layer 22a may be directly provided on a surface of the current collector 21. The first negative electrode active material layer 22a also includes a negative electrode active material and a binder. The first negative electrode active material layer 22a may further include a conductive material or the like. The first negative electrode active material layer 22a may include, for example, by mass fraction, 0% to 10% of a conductive material, more than 0% to 10% of a binder, with the remainder being a negative electrode active material. The first negative electrode active material layer 22a may include, for example, by mass fraction, 0.5% to 1.5% of a conductive material, 0.5% to 3% of a binder, with the remainder being a negative electrode active material.

The negative electrode active material in the first negative electrode active material layer 22a is not particularly limited. The negative electrode active material in the first negative electrode active material layer 22a may include a second Si-based active material. For example, the negative electrode active material in the first negative electrode active material layer 22a may further include another negative electrode active material (as described above).

When the negative electrode active material in the first negative electrode active material layer 22a includes the second Si-based active material, a mass fraction “M_{2S}” of the second Si-based active material in the first negative electrode active material layer 22a may be lower than the mass fraction “M_{1S}”. That is, a relationship of “M_{2S} <M_{1S}” or “1 <M_{2S}/M_{1S}” may be satisfied. The ratio “M_{2S}/M_{1S}” may be, for example, 1.2 or more, 2 or more, 5 or more, 10 or more, or 100 or more. The ratio “M₂/M_{1S}” may be, for example, 1000 or less, 100 or less, 10 or less, or 5 or less. The mass fraction “M_{2S}” may be, for example, 1% or more, 3% or more, 5% or more, 10% or more, 15% or more, 20% or more, or 25% or more. The mass fraction “M_{2S}” may be, for example, 30% or more, 40% or more, 50% or more, 60% or more, 70% or more, 80% or more, 90% or more, or 95% or more. The mass fraction “M_{2S}” may be, for example, 95% or less, 90% or less, 80% or less, 70% or less, 60% or less, 50% or less, 40% or less, 30% or less, 25% or less, 20% or less, 15% or less, 10% or less, 5% or less, or 3% or less.

The conductive material may include, for example, acetylene black, carbon nanotube (CNT), vapor-grown carbon fiber (VGCF), and the like. The mass fraction of the conductive material may be substantially constant throughout the entire region of the negative electrode active material layer. The mass fraction of the conductive material may be locally different. For example, the mass fraction of the conductive material may be different between the layers. For example, the types of the conductive material may be different between the layers.

The separator 30 is porous. The separator 30 can allow the electrolyte solution to pass through. The separator 30 separates the positive electrode 10 and the negative electrode 20. The separator 30 is an electrical insulator. The separator 30 may include, for example, a polyolefin-based resin such as polyethylene (PE) or polypropylene (PP). The separator 30 may have, for example, a single-layer structure or a multi-layer structure. The separator 30 may be, for example, substantially made of a PE layer, or may be constructed by laminating a PP layer, a PE layer, and a PP layer in this order.

The separator 30 includes a first surface facing the negative electrode 20 (the second negative electrode active material layer 22b). An adhesive layer (first adhesive layer) 31 is disposed on the first surface. The first adhesive layer 31 may be disposed on a part of the first surface or may be disposed on the entire surface. The separator 30 includes a second surface facing the positive electrode 10. An adhesive layer (second adhesive layer) (not shown) may be disposed on the second surface. The second adhesive layer may be disposed on a part of the second surface or may be disposed on the entire surface. It should be noted that the first adhesive layer and the second adhesive layer may be generally referred to as an “adhesive layer”. Hereinafter, when referred to simply as the “adhesive layer”, the term denotes both the first adhesive layer and the second adhesive layer.

The adhesive layer includes a binder. The binder may include, for example, at least one selected from the group consisting of SBR, CMC, PVdF, PTFE, and the acrylic polymer (as described above). The adhesive layer 31 may include inorganic particles. Examples of the inorganic particles include an aluminum compound and a magnesium compound. The mass fraction of the binder included in the adhesive layer may be, for example, 10% or more, 20% or more, 30% or more, 40% or more, 50% or more, 60% or more, 70% or more, 80% or more, or 90% or more. The mass fraction of the binder included in the adhesive layer may be, for example, 90% or less, 80% or less, 70% or less, 60% or less, 50% or less, 40% or less, 30% or less, 20% or less, or 10% or less.

The second negative electrode active material layer 22b and the first adhesive layer 31 include a binder. The binders included in the second negative electrode active material layer 22b and the first adhesive layer 31 may be the same or different from each other. The binders included in the second negative electrode active material layer 22b and the first adhesive layer 31 may be acrylic polymers.

### Reference Test 1

In order to evaluate durability depending on the presence or absence of the adhesive layer, a cycle test was performed. Evaluation cells (Nos. 1, 2) including separators on which an adhesive layer was disposed and evaluation cells (Nos. 3 to 5) including a separator on which no adhesive layer was disposed were prepared. PVdF was used as the binder in the adhesive layer of No. 1, and polyacrylic acid (PAA) was used as the binder in the adhesive layer of No. 2, respectively. In addition, the negative electrode active material layer of each evaluation cell included Si at a mass fraction of 20% as the negative electrode active material. It should be noted that the adhesive layer was disposed on both surfaces of the separator.

As shown in FIG. 4, the capacity retention rates of Nos. 1 and 2 were higher than the capacity retention rates of Nos. 3 to 5. That is, by disposing the adhesive layer, an improvement in durability is expected.

### Reference Test 2

In order to evaluate the swelling amount depending on the presence or absence of the adhesive layer, a charge-discharge test was performed. As the evaluation cells, Nos. 1 and 2 of Reference Test 1 were prepared.

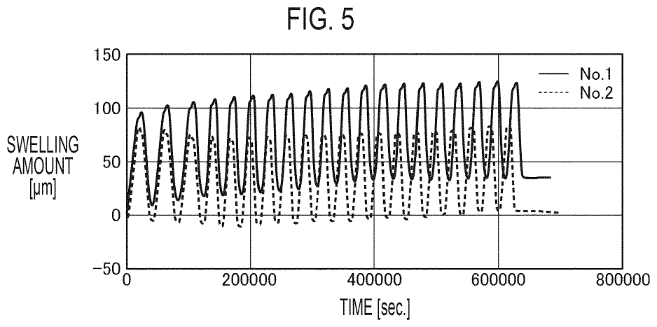

As shown in FIG. 5, the swelling amount in No. 2 was smaller than the swelling amount in No. 1. That is, by using PAA as the binder in the adhesive layer, the swelling amount is expected to be reduced.

### Reference Test 3

In order to evaluate the adhesion strength depending on the presence or absence of the adhesive layer, a peel test was performed. As the evaluation cells, Nos. 1 and 2 of Reference Test 1 were prepared.

In No. 1, the separator was peeled off without the positive electrode active material layer and the negative electrode active material layer adhering to the separator. In No. 2, the positive electrode active material layer and the negative electrode active material layer adhered to the separator. That is, by using PAA as the binder in the adhesive layer, the separator and each active material layer are expected to adhere firmly to each other.

What is claimed is:

1. An electrode member comprising:
a current collector;
a first negative electrode active material layer;
a second negative electrode active material layer; and
a separator, in order of the current collector, the first negative electrode active material layer, the second negative electrode active material layer, and the separator, wherein:
the second negative electrode active material layer includes a first Si-based active material;
the separator includes a first surface facing the second negative electrode active material layer; and
an adhesive layer is disposed on the first surface.

2. The electrode member according to claim 1, wherein:
the first negative electrode active material layer includes a second Si-based active material; and
a mass fraction of the second Si-based active material in the first negative electrode active material layer is lower than a mass fraction of the first Si-based active material in the second negative electrode active material layer.

3. The electrode member according to claim 1, wherein:
the second negative electrode active material layer and the adhesive layer include a binder; and
the binder includes an acrylic polymer.

4. The electrode member according to claim 2, wherein the first Si-based active material and the second Si-based active material include at least one selected from the group consisting of Si, a Si-based alloy, SiO, and a Si—C composite material.
